(19) United States
(12) Patent Application Publication
(10) Pub. No.: US 2004/0076151 A1
(43) Pub. Date: Apr. 22, 2004

(54) Connection identifiers and restoration in optical networks

(76) Inventors: Walter Fant, Los Gatos, CA (US); Ayan Banerjee, Mountain View, CA (US); John Drake, Pittsburgh, PA (US)

Correspondence Address: BLAKELY SOKOLOFF TAYLOR & ZAFMAN, 12400 WILSHIRE BOULEVARD, SEVENTH FLOOR, LOS ANGELES, CA, 90025, US

(21) Appl. No.: 10/274,823

(22) Filed: Oct. 21, 2002

(51) Int. Cl. H04L 12/66

(52) U.S. Cl. 370/389; 370/395.5

(57) ABSTRACT

A method is described that includes accessing a signaling message for a frame to be transmitted through an optical network along a path, deriving an identifier of the path using the signaling message, attaching the identifier to an overhead section of the frame, and transmitting the frame through the optical network on the path with the attached identifier. For another embodiment, an apparatus is described that includes a controller coupled to a control plane of an optical network to receive a signaling message on a control plane, the signaling message specifying a change in a connection for a specified optical network communications circuit, and to forward the signaling message on the control plane, and an interface to an optical switching matrix to change the connection for the specified circuit after forwarding the signaling message.

### FIELD

Embodiments pertain to the field of optical data communications networks. More particularly, such embodiments relate to improving the reliability of connections in such networks using unique connection identifiers and enhanced restoration techniques.

### BACKGROUND

Fiber optic communications networks are deployed to provide high speed, high reliability, high capacity communications for a broad range of traffic, including data, voice, video, audio, and other types of information. The benefits of optical networks are further advanced by using optical switching devices within the networks. These switching devices dynamically switch light beams from input optic fibers to output optic fibers without converting the light beam from the optical to the electrical domain and back to the optical domain. Optical switches offer higher speed, greater flexibility and higher reliability than electronic switches. Optical switches can demonstrate optical transparency, scalability, and cost effectiveness.

For many applications, including telecommunications, an optical network can be required to provide reliability comparable to electrical telephony networks especially in the face of major network equipment failures. Typically, the service offered is a reliable optical connection between a pair of nodes. Service disruptions due to failed equipment or cut fibers can be minimized by quickly re-establishing or restoring the optical connections through an alternate path.

In many SONET (Synchronous Optical Network) systems, the connection protection and restoration schemes used to recover from network failures are based on ring topologies that use dedicated protection resources. However, such a ring topology uses the communications equipment less efficiently than a shared mesh topology. This is even more true in a transparent optical network such as those enabled by purely optical switching matrices. In a shared mesh topology, the protection resources can be shared by many connections and only allocated when an actual failure has occurred. However, in shared mesh topologies, the distributed control makes it difficult to achieve restoration performance that is competitive with ring topologies.

The connection restoration times in a shared mesh topology depend on many factors. One of the most significant of these factors can be the time required to synchronize between the control plane and the data plane to ensure data integrity and privacy during the network reconfiguration process. In a system using GMPLS (Generalized Multiprotocol Label Switching, a standard of the IETF (Internet Engineering Task Force)) for example, a signaling message (called PATH) in GMPLS is transmitted on a control plane to each switch in the network in a specific order along the path. Typically, the switches are reconfigured one at a time during the RESV flow (which are confirmation messages in the reverse direction of the setup message flow) in order along the path. This prevents any data already in the network from being directed along the wrong path.

The problem of misdirected optical data arises when (a) the protection resources, that are allocated to carry lower priority connections during the times that the network is stable, are pre-empted when failures occur or (b) switches are configured along with the setup signaling message flow to reduce connection setup times. While the lower priority data connections increase the capacity of the network, this data runs a higher risk of being misdirected. In the event of a failure of a higher priority connection that is protected, the lower priority connection may be pre-empted and the network resources dynamically reconfigured to carry the higher priority connection. During this reconfiguration process, the data from the customer using the lower priority connection may be mistakenly sent to the customer using the higher priority connection and vice-versa, reducing the privacy and integrity of the data. Conventionally, to maintain the integrity of the data, the control plane and the data plane are synchronized to ensure that all network reconfiguration occurs in a precise ordered fashion and that no data is enabled until the network has stabilized. However, the signaling latency from this synchronization process detracts directly from how quickly a connection can be restored after a failure.

When optical data is misdirected it can be very difficult to determine which data is misdirected and which data is not. There is no simple robust system for optical networks that allows a node to determine whether received data is properly received. Optical transport systems such as SONET do allow an identifier to be added in the transport overhead of a data payload. However, no messages have been defined that allow a quick and simple confirmation to be made for received data. More recently, ITU G.709 “digital wrapper” standards (a ITU-T standard (International Telecommunications Union-Telecom Standardization)) have provided for a trail trace identifier (TTI) byte as part of the OTU (Optical Transport Unit) frame overhead. The ITU G.709 TTI byte allows a 64 byte message containing a source and destination identifier to be carried within an OTU superframe. This identifier has been used to validate that each segment of connection through an optical network has been correctly configured and established. If a connection in the network is configured incorrectly, the error can be detected and a management system alarm can be generated. However using a TTI alone in the data plane overhead does not reduce signaling latency or improve restoration performance.

### SUMMARY

A method is described that includes accessing a signaling message for a frame to be transmitted through an optical network along a path, deriving an identifier of the path using the signaling message, attaching the identifier to an overhead section of the frame, and transmitting the frame through the optical network on the path with the attached identifier.

For another embodiment, an apparatus is described that includes a controller coupled to a control plane of an optical network to receive a signaling message on a control plane, the signaling message specifying a change in a connection for a specified optical network communications circuit, and to forward the signaling message on the control plane, and an interface to an optical switching matrix to change the connection for the specified circuit after forwarding the signaling message.

Other features and advantages of the present invention will be apparent from the accompanying drawings, and from the detailed description, which follows below.

### BRIEF DESCRIPTION OF THE DRAWINGS

Embodiments of the present invention are illustrated by way of example and not limitation in the figures of the accompanying drawings in which like references indicate similar elements and in which:

FIG. 1 shows a simplified block diagram of an optical network to which an embodiment of the present invention can be applied;

FIG. 2 shows a simplified block diagram of a client interface card such as those of FIG. 1;

FIG. 3 shows an example frame format for frames sent over the optical network of FIG. 1;

FIG. 4 shows a network topology with primary and secondary paths for routing a frame such as that of FIG. 3;

FIG. 5 shows the network topology of FIG. 4 after a fault has been detected and on primary path has been re-routed; and

FIG. 6 shows flow charts for three independent processes implemented in an embodiment of the present invention.

### DETAILED DESCRIPTION

A connection identifier can be inserted into the transport overhead of an optical network frame and then used to ensure integrity and privacy for each delivered frame. This independent verification of each frame can be exploited when connection failures are restored. When a link in the network fails, the network control plane can be allowed to orchestrate the necessary network reconfiguration in the quickest possible way. There is no need to synchronize the nodes or account for misrouted and lost frames. When the connection is restored, the connection identifier can be used to discard misrouted optical data frames and deliver only the appropriate ones. The connection identifier can also be used to confirm that the network has been properly reconfigured. As a result, the network is made more robust, more secure, and more reliable. At the same time, a mesh network topology can be used to reduce the cost of the network per transmitted frame.

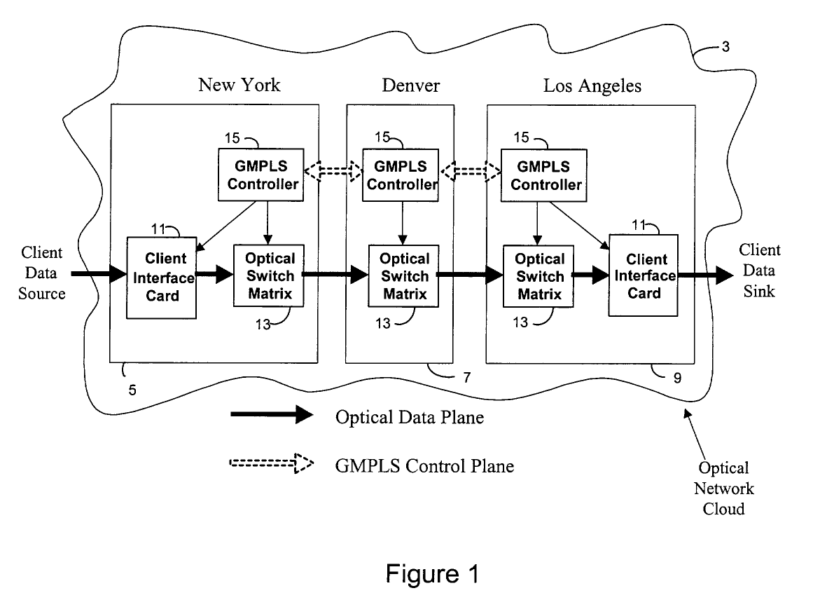

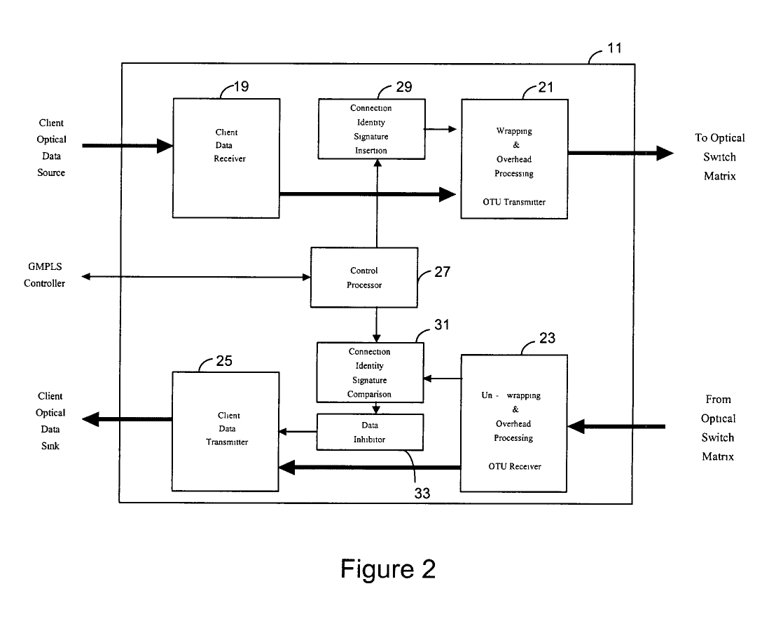

FIG. 1 shows an example of a simple optical network cloud 3 that is built using a simple linear topology. While mesh failure restoration cannot be illustrated by this topology, it provides a simple illustration of data and control plane flows. The topology shown in FIG. 1 has three nodes: an ingress or source or originator node 5 labeled “New York,” an intermediate node 7 labeled “Denver,” and an egress or destination or terminator node 9 labeled “Los Angeles.” Each end node 5, 9 can be constructed using a client interface card 11, an example of which is shown in more detail in FIG. 2. The client interface card receives and transmits data between the client and the optical network. It can be coupled to a WAN (Wide Area Network), LAN (Local Area Network), server computer, stand-alone computer or terminal or any of a variety of other data, video, or voice communications devices.

Such a card is capable of examining the data in the electrical domain as the data transits through the node. More importantly, as described in more detail below, the node can be configured so that at the ingress location, the card is capable of receiving the client data, manipulating the transport overhead, and placing a unique connection identifier signature into the transport overhead to create an optical transport unit (OTU) frame. At the egress location, the card can be configured to be able to take the network OTU frame, examine the transport overhead bytes, compare the connection identifier signature, and hand the payload data back to the client.

Each of the nodes also includes an optical switch matrix 13. At the ingress node, the optical switch matrix is coupled to the client interface card so that client data can be transferred from the client into the optical network. At the egress node, the optical switch matrix is coupled to the client interface card so that client data can be transferred from the optical network to the client. The optical switch matrices are coupled together through a data plane that carries the client data through the network. The specific nature of the optical network can be selected to suit any particular application. While embodiments of the present invention will be described in the context of a G.709 “digital wrapper” as the transport unit, it may also be applied to SONET (Synchronous Optical NETwork) transport overhead and data encapsulation, as well as to many other optical network standards and systems.

In FIG. 1, one node 5 is shown as a data source node and the opposite node 9 is shown as a data sink. However, the roles can be reversed or a two-way communications path having both a forward and a reverse direction can be established so that both nodes serve as both sinks and sources. The path through the network may or may not be the same in the forward direction as in the reverse direction. The single one-way path is used in the present example for simplicity of explanation.

In addition to the data plane interconnecting the optical switch matrices, there is a control plane that operates independently of the data plane. The control plane can be operated on the same physical carrier or on an independent carrier, such as an Ethernet. The control plane carries far less traffic than the data plane and so can be provided in many other ways. For one embodiment, the control plane is the GMPLS (Generalized Multi-Protocol Label Switching, an IETF standard) control plane. Each node has a GMPLS controller 15 that is coupled to the control plane. Each GMPLS controller is also coupled to the optical switch matrix of the node and, in the case of the end nodes, the GMPLS controller is coupled to the respective client interface card 11. The GMPLS controller can be implemented in a variety of different ways. For one embodiment, it is constructed as a general purpose computer with the appropriate interface cards to enable the described communications links. The functions, messaging, and interfaces can be performed by software. For another embodiment, a special purpose machine can be provided to implement the functions, messaging, and interfaces in hardware, software, firmware, or some combination thereof.

The structure shown in FIG. 1 is conventional and can be used in a SONET or G.709 system as well as many other optical networking systems. To establish a connection through the network, the originating node 5 (New York) computes a route using a GMPLS link state database through the network to the desired egress node 9, Los Angeles. For one embodiment, the OSPF-TE (Open Shortest Path First-Traffic Engineering an IETF standard) link state database can be used. In this example, only one possible route is shown and it is the route from New York to Denver to Los Angeles.

GMPLS signaling is used between the GMPLS controllers over the control plane to establish the path. For one embodiment, RSVP-TE (Resource Reservation Protocol-Traffic Engineering an IETF standard) signaling (PATH and RESV message) can be used. On obtaining a connection setup request, the originating node's GMPLS controller 15 generates a GMPLS RSVP-TE PATH message, which includes a Session Object and a Sender Template object by following RSVP processing rules. In response to the PATH message each GMPLS controller forwards the PATH message and configures its corresponding optical switch matrix 13 to establish the connection locally. A frame containing the client data can then be carried on the data plane from the ingress node to the egress node.

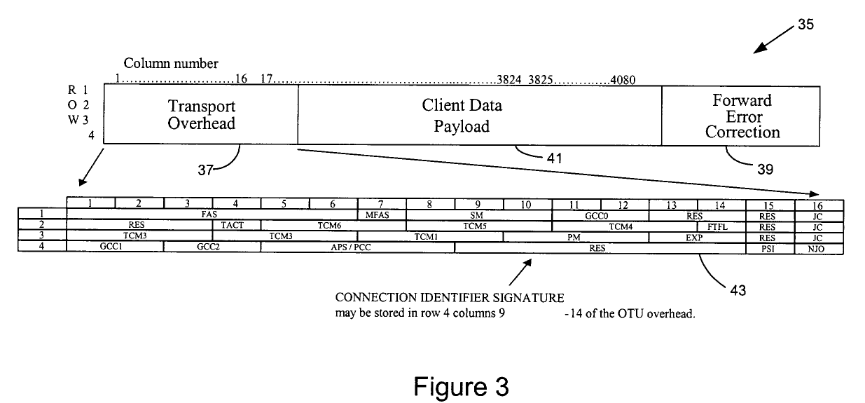

FIG. 2 shows a functional block diagram of an example of a client interface card 11 suitable for use as a transponder for G.709 communications. The client interface card can be modified from conventional designs to suit embodiments of the present invention. In the illustrated example, the card has an upper transmit path and a lower receive path with a control path in the middle. The transmit path receives optical data from the client at a client data receiver 19. The receiver performs any interface signaling and modulation functions necessary to resolve client data in the native client format. The data is then passed to an OTU (Optical Transport Unit) transmitter 21. The transmitter formats the data for transmission through the optical network. For a G.709 transponder card, this includes building the OTU frame shown in FIG. 3. The transmitter then passes the data to the optical switch matrix 13 which forms an interface to the optical network.

Similarly on the receive side, OTU frames are received at the OTU receiver 23 from the optical switch matrix. The frames are demodulated, unwrapped, errors are corrected and any overhead is processed so that the data can be passed to a client data transmitter 25. From the client data transmitter, the data is demodulated and formatted as necessary to be provided to the client.

The receive and transmit paths handle data that is carried on the optical data plane. A separate control plane is also provided to receive and send messages between GMPLS controllers 15. Messages on the control plane can be passed from the GMPLS controller to a control processor 27 of the client interface card. The messages can relate to any of a variety of different control functions, including functions related to transmit and receive paths.

For one embodiment of the present invention, before the client data is sent, a unique connection identifier signature is inserted into the frame that carries the data. The connection identifier signature is a network-wide unique value that can be used to identify the optical frames carried by the connection. In a circuit switched system, such as SONET and G.709, each connection can be considered a circuit, so that the connection identifier signature is a type of circuit identification. Any value can be used for the connection identifier signature including a sequential assignment, a selection from a pre-determined look-up table or a pseudo-random number. However, network operation is simplified if the connection identifier signature can be derived from other information already in the network.

Within the ingress client interface card 11, the connection identifier signature is added into the transport overhead in the OTU (Optical Transport Unit) frame and it is validated on the received OTU frame. If the received connection identifier signature does not match the expected value, then the client data will be inhibited so as to prevent the possibility of sending incorrect data to the client.

For one embodiment, the connection identifier signature is derived from a routing message or a signaling message sent over the control plane. In a GMPLS signaling system, the RSVP-TE PATH message can be used. This message is defined in the RSVP-TE standards. The RSVP-TE PATH message includes a 5-tuple comprising a four-byte Source-Id, a four-byte Destination-Id, a two-byte LSP (Label Switched Path)-Id, a two-byte Tunnel-Id, and a four-byte Extended Tunnel-Id (16 bytes). This 5-tuple can be used directly as the network-wide unique connection identifier in an RSVP system. Alternatively, the connection identifier signature can be derived from this 5-tuple by, for example, taking the four-byte source node ID, which is the IP (Internet Protocol) address of the source node, and the two-byte tunnel ID. This six-byte combination is network unique since the IP address of the source node is unique and each connection within that node can be given a unique tunnel ID number.

The connection identifier signature can be added to the frame in any of a variety of different ways and the precise choice will depend upon the particular frame format used and the standards employed. FIG. 3 shows the OTU frame 35 that is used in G.709. The frame includes 4 rows and 4080 columns. The first 16 columns are designated for transport overhead 37 and the last 255 columns are designated for forward error correction 39. The remaining columns are designated for user data or client data payload 41.

Within the transport overhead, shown exploded in FIG. 3, many of the bytes have been designated for specific purposes but many others are indicated as reserved (RES). The connection identifier signature can be inserted anywhere in the overhead. However, selecting a reserved location reduces the possibility of conflict with other messages. One such location 43 is in row 4, columns 9-14 of the OTU overhead. The six bytes inserted there will be transmitted every G.709 frame. Frames are transmitted every 12 microseconds (for an OTU-2 frame) which allows the integrity of every OTU data frame to be rapidly validated. As an alternative to the connection identifier signature described above, the G.709 TTI (trail trace identifier) message can be used to carry a unique connection identifier. However, care must be taken to avoid conflicts with other uses of the TTI bytes. In addition, the TTI bytes are transmitted at a lower rate of four times per OTU multiframe. This makes the TTI bytes less precise for validating the integrity each frame of client data.

Referring to FIG. 2, for one embodiment, the connection identifier signature is passed from the ingress node GMPLS controller 15 to the client interface card 11 control processor 27. The control processor can then provide it to an insertion module 29 that is coupled to the OTU transmitter 21. This allows the OTU transmitter to insert the connection identifier signature into the transport overhead of the OTU frame as it creates the frame for the optical network. The connection identifier signature will then be carried with the frame across the data plane to the destination node 9.

The complete 5-tuple connection information is also carried transparently to the destination node 9 within the GMPLS PATH message on the GMPLS control plane. The GMPLS controller 15 of the destination node on reception of the PATH message extracts the connection information, calculates the connection identifier signature, and passes it to its client interface card 11.

Referring to FIG. 2, the client interface card receives the connection identifier signature at the control processor 27. The control processor passes it to a connection identity signature comparison module 31. Once the connection identity information signature has been confirmed through the control plane to have been received by both the source node and the destination node client interface cards, the client data transponders in each card are enabled to control the flow of information. The comparator module is also coupled to the OTU receiver so that it can receive the connection identity signature received in the transport overhead of each frame. The comparator compares the received value to the derived and expected value and, if the values do not match, the comparator then passes a signal to a data inhibitor 33. The data inhibitor is coupled to the client data transmitter to inhibit the further transmission of the data payload received in the mismatched frame.

For simplicity, the control processor of FIG. 2 is shown as being connected only to an insertion 29 and a comparison 31 module. However, the control processor can be coupled to every aspect of the interface card including components and modules not shown in order to allow it to act as a central controller for the card. Alternatively, the control processor can act only as a GMPLS interface and a separate main controller for the card can perform all other necessary control functions.

In the simple network of FIG. 1, the client data flow is enabled when the client data receiver at the destination node detects that the proper connection identifier signature has been received in the OTU frame. This is useful to protect against connection setup errors and spurious errors. However, as described below, the signature can also be used in enabling very high performance connection restoration in the event of a network failure. This is better described with a more complex network topology.

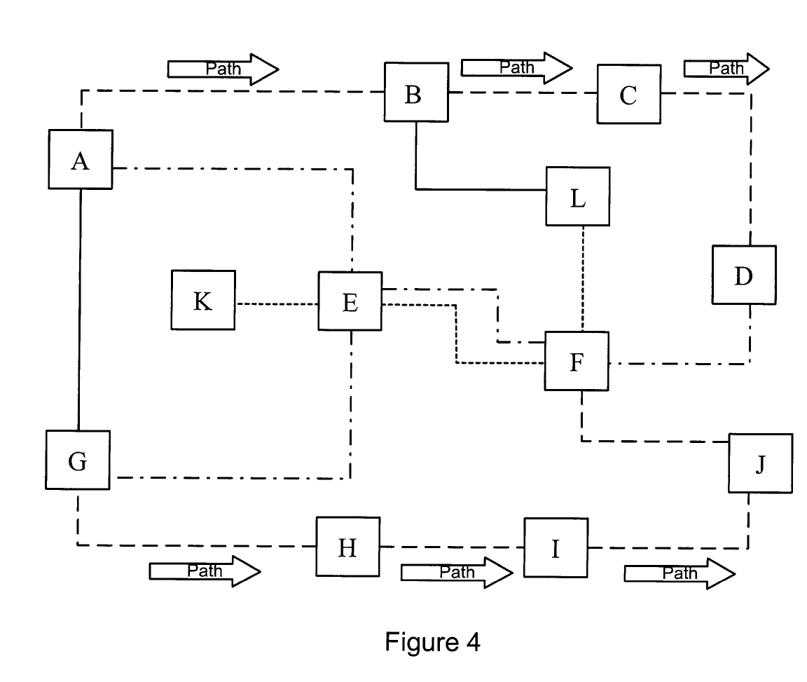

Referring to FIG. 4, twelve nodes (A through J) are depicted in a simple shared mesh topology optical network that uses shared mesh protection with best effort traffic. A connection can be set up using A-B-C-D as a primary path and A-E-F-D as a disjoint secondary path that protects it. Another connection can be set up using G-H-I-J as a primary path and G-E-F-J as a disjoint secondary path that protects it. Note that both secondary paths use the link between E and F. There can also be a low priority best effort connection on a path K-E-F-L. Prior to a network fault in either primary path, the E-F link is not used so it may be used by this low priority best effort traffic.

For one embodiment, the source nodes for the two primary/secondary path pairs, nodes A and G, compute the routes for the primary and secondary paths simultaneously, using a GMPLS link state database. These originating nodes also ensure that the primary paths are disjoint from the corresponding secondary path. As in the simple linear network case, these two nodes then use GMPLS signaling over the control plane, for example, RSVP-TE (PATH and RESV messages), to establish the primary and secondary paths. A bit in the PATH message, sent to each node from the originating node to the terminating node indicates to the respective node whether the path that is being established is a primary path or a secondary path.

If the path that is being established is a primary path, then the nodes along the path (originating node, intermediate nodes, and terminating node) each program their optical switch matrix to establish the path in both the forward and reverse directions for a bidirectional connection. Alternatively, one-way paths can be established for uni-directional connections. If a best effort path (i.e., a lower priority path) is using the resources needed to establish the path, (e.g., input and output links and wavelength), then the best effort path is pre-empted.

If the path that is being established is a secondary path, then the nodes along the path do not establish the path by making connections through the optical switches. Instead, those nodes record the resources requested by the path. This allows those resources to be used by other best effort paths (such as K-E-F-L) or other secondary paths until the originating node reclaims them by sending a subsequent PATH message indicating that the secondary path is now a primary path. This process by which the PATH message sent through the control plane activates the secondary path is defined as secondary path activation.

After the paths are established, the connection is setup and activated. At this time, the details of the connection or circuit have already been exchanged between the end-points using the GMPLS control plane. From the control plane information, the GMPLS controller at each node can derive the connection identification signature appropriate for the particular circuit. As described above, there is a G.709 client interface card at both ends of every primary/secondary path pair (seen at nodes A, D, G, J, K, and L). These cards forward customer data only when the G.709 frame has a valid connection identifier signature. In order to prevent the possibility of misdirected customer light when activating a secondary path, the connection identifier signature is carried in the G.709 transport overhead header of every OTU that is sent over a given path for a given connection. Misdirected customer optical data can come from a partially activated secondary path or it might be directed onto a best effort path that is being pre-empted at some intermediate node. If the G.709 client interface cards receive a G.709 OTU on a path with a value different from the value established for that connection, they will discard it, as described above.

In order to allow intermediate nodes to share protection resources, the route taken by the primary path is carried in the PATH message that is used to establish the associated secondary path. An intermediate node compares the route taken by the primary path with the routes of other primary paths whose secondary paths use the same resources as the secondary path being established. If the primary paths are disjoint then the protection resources may be shared. Accordingly, in the event of a single network failure, all affected primary paths will be able to activate their associated secondary paths without any protection resource contention.

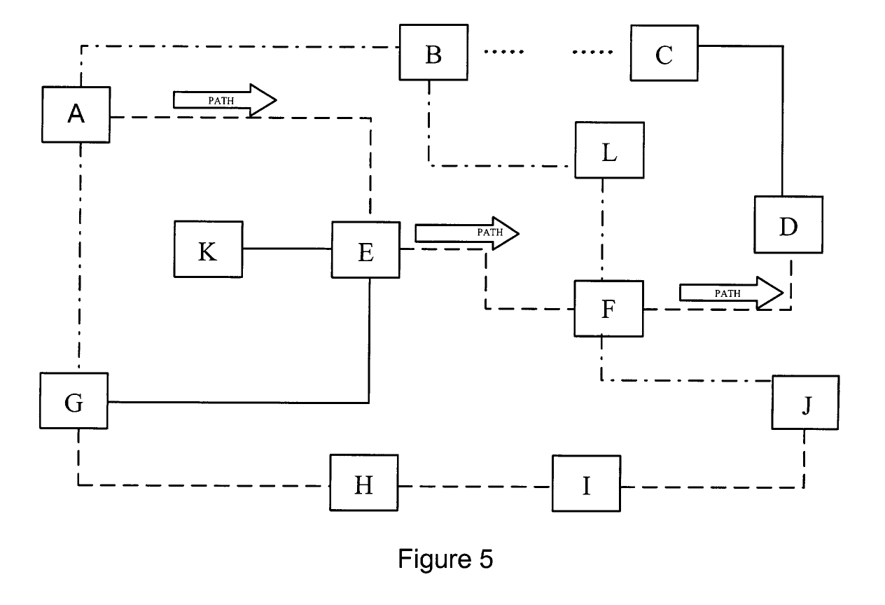

FIG. 5 shows an example restoration scenario in which the link between nodes B and C has failed. This causes the client interface card G.709 transponders at either end of the primary path A-B-C-D to detect failure. Failure can be detected in any of a variety of different ways including, the loss of light (LOL), loss of signal (LOS), remote defect indication (RDI) or backwards defect indication (BDI). This detection will happen in the time it takes for LOL, LOS, RDI, or BDI to propagate, at the speed of light, to the primary path connection endpoints.

Because the primary/secondary path pairs are disjoint, when node A—as the originating node—detects the failure of the primary path A-B-C-D, node A can immediately begin the activation of the associated secondary path A-E-F-D. Node A can do so without waiting to determine the reason for the failure. Any failure in the A-B-C-D path will be independent of a failure in the A-E-F-D path. Avoiding any necessity to determine the failure reduces the latency of the restoration. The fault can later be isolated using the GMPLS LMP fault isolation procedures or any other process appropriate to the particular network. The appropriate policies can be applied across the control plane to reconfigure the network to protect against other faults.

In FIG. 5, node A sends a PATH message, indicating that the path A-E-F-D is now a primary path, which is forwarded by nodes E and F, eventually reaching node D. The PATH message is first forwarded to each other node in the path, then each of the nodes, in parallel programs its optical switch matrix locally to establish the path in both the forward and reverse directions. Forwarding the PATH message before making the switch further reduces the amount of time required to activate the secondary path. Because the nodes are all working virtually in parallel, and not in series or one at a time, the switching occurs more quickly. To activate the secondary path, nodes E and F pre-empt the best effort path K-E-F-L and notify nodes G and J that the secondary path G-E-F-J no longer has the segment E-F. When the destination node D processes the PATH message, it sends a RESV message back to the source node A on the control plane. While PATH and RESV messages are used here as examples, other signaling can be used as appropriate for the particular protocols for an application.

When the client interface card at node D detects a valid G.709 frame, the client interface card turns off the BDI, or other fault message. The other primary path G-H-I-J continues to operate. However, its secondary path has been preempted as well. Accordingly, connection G-H-I-J computes a new secondary path, such as G-A-B-L-F-J. The pre-empted best effort traffic is also re-routed. This re-routing can be policy driven.

During the entire protection-switching period, there is no synchronization between the control and data planes nor did the G.709 transponders on the client interface cards turn off. As a result, the instant that all four nodes along the path, in the example above, have processed the PATH message and programmed their switch matrices, the connection between A and D is restored and the transponders are reconnected. During this network fault recovery process, the control plane has requested that the optical switch matrices of the nodes within the network reconfigure as quickly as possible without any consideration to traffic being misrouted during the reconfiguration process. Any misrouted data will be contained within the optical cloud and discarded by the client interface cards at the edge of the network. If necessary to the client, this data can be recovered by the client by requesting a retransmission from the external source. This process is handled by higher network layers.

No explicit verification of the activated secondary path is required. This saves still more time. The restored path is verified implicitly when traffic is received at the originating and terminating nodes with the correct connection identifier signature contained in the G.709 transport overhead. The receipt of the G.709 encoded traffic at the destination node with the correct connection identifier signature in the transport overhead notifies the destination node that data can be forwarded out to the client data port. Data is not passed to the client data ports until the correct connection identifier signature is present on the network side of the path. This approach provides for self-synchronization of the data. It does not require any control plane signaling in order to enable data transmission during the restoration process. The self-synchronization provides a significant performance improvement over other methods that require this synchronization. In the above example, a single network failure was illustrated, however, the operation for restoration of secondary paths for affected connections holds true for multiple network failures as well.

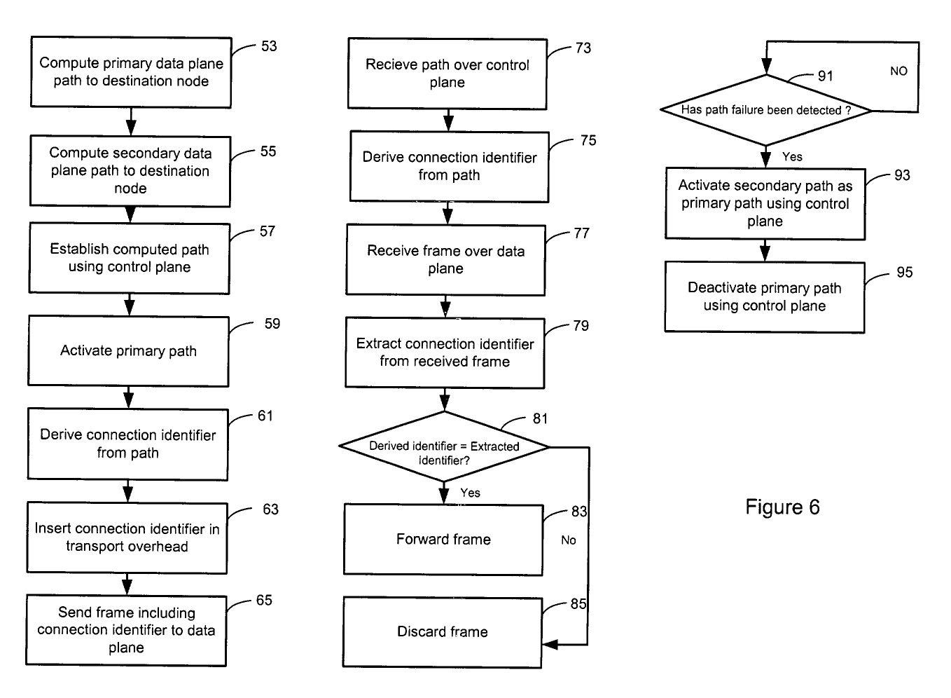

For some embodiments described above, the operation of the network can be considered as three independent processes comprising transmission, reception, and connection restoration. Due to the use of a connection identifier signature, the restoration process does not need to be coordinated with the transmission and reception process and vice versa. FIG. 6 shows brief summary flow charts of the three separate example processes for one embodiment of the present invention. One process is the process at the originating or source node. The list of operations is provided only as an example. All or some of this process can be completed in other locations and the steps can be performed in a different order than described.

As shown in FIG. 6, at operation 53, when it has been determined that client data is to be communicated through the optical network, the origination node computes a primary data plane path to the appropriate destination node. At operation 55, the origination node also computes a secondary data plane path to the same destination node. The route computation for primary and secondary paths may be done synchronously in another embodiment of this process. At operation 57, the computed paths can then be established using the control plane. At some time after the paths are established, at operation 59, the primary path is activated. At operation 61, the connection identifier is derived from the path and at operation 63, inserted into the transport overhead of outgoing frames. At operation 65, the frames are then sent including the connection identifier to the data plane.

The destination node and any intermediate nodes that are so enabled run a similar process in reverse. At operation 73, the destination node receives a message indicating the path over the control plane. At operation 75, the destination node derives the connection identifier from the path and at operation 77, receives frames over the data plane. As described above a GMPLS PATH message can be used. However, other knowledge of the path taken by the frame through the network can be used instead in order to derive the identifier. At operation 79, the connection identifier can then be extracted from the received frames. At operation 81, if the derived identifier matches the extracted identifier, then at operation 83, the frame is forwarded. If not, then at operation 85, the frame is discarded. Note that for a bidirectional connection, the connection identifier signature can be reused for both directions of the connection.

Due to the optical path integrity which is assured by the two processes above, the restoration process can operate completely independently. The restoration process can be run by any node in the network or by an external agent. In many applications it is run by either the source node or the destination node. In the restoration process, at operation 91, a path failure is detected or not. If a path failure is not detected, then the system continues to monitor for one. If a path failure is detected, then at operation 93, the secondary path is activated as the primary path using, for example, control plane signaling. This can be done without any synchronization, as described above. At the same or another time, at operation 95, the primary path is deactivated using the control plane. Any misdirected optical data frames are handled by the separate processes just described above.

Embodiments of the invention includes various operations or steps. The operations of embodiments of the invention may be performed by hardware components as shown or may be embodied in machine-executable instructions, which may be used to cause a general-purpose or special-purpose processor or logic circuits programmed with the instructions to perform the steps. Alternatively, the operations may be performed by a combination of hardware and software.

Aspects of embodiments of the invention may be provided as a computer program product which may include a machine-readable medium having stored thereon instructions which may be used to program a computer (or other electronic devices) to perform a process according to embodiments of the present invention. The machine-readable medium may include, but is not limited to, floppy diskettes, optical disks, CD-ROMs, and magneto-optical disks, ROMs, RAMs, EPROMs, EEPROMs, magnet or optical cards, flash memory, or other type of media/machine-readable medium suitable for storing electronic instructions. Moreover, aspects of embodiments of the invention may also be downloaded as a computer program product, wherein the program may be transferred from a remote computer to a requesting computer by way of data signals embodied in a carrier wave or other propagation medium via a communication link (e.g., a modem or network connection).

Importantly, while embodiments of the invention have been described in the context of G.709 “digital wrapper” optical network, embodiments of the invention can be applied to a wide variety of optical network applications. It is not necessary that the control plane and the data plane be physically separate, nor is it necessary to use GMPLS signaling. Any protocol that supports independent validation of the frames can be used. Many of the structures and methods are described in their most basic form but steps or operations can be added to or deleted from any of the described structures and methods without departing from the basic scope of the present invention.

In the foregoing specification, the invention has been described with reference to specific exemplary embodiments thereof. It will, however, be evident that various modifications and changes may be made thereto without departing from the broader spirit and scope of the invention as set forth in the appended claims. The specification and drawings are, accordingly, to be regarded in an illustrative rather than a restrictive sense.

What is claimed is:

1. A method comprising:
accessing a signaling message for a frame to be transmitted through an optical network along a path, the signaling message relating to the path;
deriving an identifier of the path using the signaling message;
attaching the identifier to an overhead section of the frame; and
transmitting the frame through the optical network on the path with the attached identifier.

2. The method of claim 1, wherein accessing a signaling message comprises accessing a signaling message of the frame using a control plane of the optical network

3. The method of claim 1, wherein accessing a signaling message comprises reading a path message from a signaling protocol of the optical network.

4. The method of claim 3, wherein the path message includes a source-ID and a tunnel-ID and wherein deriving an identifier comprises building a key using a combination of the source ID and the tunnel-ID.

5. The method of claim 1, wherein accessing a signaling message comprises reading identification codes for nodes of the path through the optical network.

6. The method of claim 1, wherein deriving an identification comprises building a key using node identification codes.

7. The method of claim 6, wherein the node identification codes include an originating node and a node between the originating node and a terminating node.

8. The method of claim 1, wherein attaching the identifier comprises adding the identifier to a transport overhead header of the frame.

9. The method of claim 1, further comprising:
upon receiving notification of failure of the path, activating a secondary path;
attaching the identifier to frames to be sent over the secondary path; and
transmitting the frames through the optical network on the secondary path with the attached path identifier.

10. The method of claim 9, further comprising establishing a primary path and a secondary path for a series of frames to be transmitted through an optical network;

11. A machine-readable medium having stored thereon data representing instructions which, when executed by a machine, cause the machine to perform operations comprising:
accessing a signaling message for a frame to be transmitted through an optical network along a path, the signaling message relating to the path;
deriving an identifier of the path using the signaling message;
attaching the identifier to an overhead section of the frame; and
transmitting the frame through the optical network on the path with the attached identifier.

12. The medium of claim 11, wherein the instructions for accessing a signaling message comprise instructions which, when executed by the machine, cause the machine to perform further operations comprising accessing a signaling message of the frame using a control plane of the optical network

13. The medium of claim 11, wherein the instructions for accessing a signaling message comprise instructions which, when executed by the machine, cause the machine to perform further operations comprising reading a path message from a signaling protocol of the optical network.

14. The medium of claim 11, wherein the instructions for attaching the identifier comprise instructions which, when executed by the machine, cause the machine to perform further operations comprising adding the identifier to a transport overhead header of the frame.

15. The medium of claim 11, further comprising instructions which, when executed by the machine, cause the machine to perform further operations comprising:
upon receiving notification of failure of the path, activating a secondary path;
attaching the identifier to frames to be sent over the secondary path; and
transmitting the frames through the optical network on the secondary path with the attached path identifier.

16. An apparatus comprising:
means for accessing a signaling message for a frame to be transmitted through an optical network along a path, the signaling message relating to the path;
means for deriving an identifier of the path using the signaling message;
means for attaching the identifier to an overhead section of the frame; and
means for transmitting the frame through the optical network on the path with the attached identifier.

17. The apparatus of claim 16, wherein the means for accessing a signaling message comprises means for accessing a signaling message of the frame using a control plane of the optical network

18. The apparatus of claim 16, wherein the means for accessing a signaling message comprise means for reading identification codes for nodes of the path through the optical network.

19. The apparatus of claim 18, wherein the means for deriving an identification comprises means for building a key using node identification codes.

20. An apparatus comprising:
a controller to access a signaling message for a frame to be transmitted through an optical network along a path, the signaling message relating to the path;
a processor to derive an identifier of the path using the signaling message;
an insertion module coupled to the controller and to the processor to attach the identifier to an overhead section of the frame; and
a transmitter to transmit the frame through the optical network on the path with the attached identifier.

21. The apparatus of claim 20, wherein the controller comprises a GMPLS (Generalized Multiprotocol Label Switching) controller coupled to a control plane of the optical network and the signaling message comprises a path message of the GMPLS protocol.

22. The apparatus of claim 21, wherein the path message includes a source-ID and a tunnel-ID and wherein the GMPLS controller derives the identifier by building a key using a combination of the source ID and the tunnel-ID.

23. A method comprising:
receiving a signaling message for a frame carried on an optical network, the frame having an overhead portion;
receiving the frame on the optical network from a source node;
reading the overhead portion of the frame to obtain a path identifier for the frame;
comparing the signaling message to the path identifier received in the data frame; and
alternately discarding the frame if the signaling message and the data frame path identifier do not correspond or forwarding the frame if the signaling message and the data frame path identifier do correspond.

24. The method of claim 23, wherein receiving a signaling message comprises reading a path message from a signaling protocol of the optical network.

25. The method of claim 24, wherein the path message includes a source-ID and a tunnel-ID and wherein comparing comprises comparing the source-ID and the tunnel-ID of the path message to codes of the path identifier.

26. The method of claim 23, wherein receiving a signaling message comprises reading identification codes for nodes of the path through the optical network.

27. The method of claim 26, wherein the node identification codes include an originating node and a node between the originating node and a terminating node.

28. The method of claim 23, wherein comparing comprises comparing nodes identified in the signaling message to nodes identified in the path identifier.

29. The method of claim 23, wherein the overhead portion containing the path identifier is a part of the received frame and the signaling message is received on a control plane of the optical network.

30. The method of claim 23, wherein the frame is transmitted in a switched circuit, the method further comprising;
receiving a second different signaling message for the switched circuit;
receiving further frames of the switched circuit after receiving the second different signaling message;
comparing the path identifier derived from the first signaling message to the path identifier for the further frames; and
alternately discarding further frames if the path identifier derived from the first signaling message and the path identifier for the further frames do not correspond or forwarding further frames if the two path identifiers path identifier derived from the first signaling message and the path identifier for the further frames do correspond.

31. The method of claim 30, further comprising deriving a path identifier from the first signaling message, wherein comparing comprises comparing the derived path identifier to the obtained path identifier, and wherein comparing the second different signaling message to the path identifier for the further frames comprises comparing the derived path identifier to the signaling path identifier for the further frames.

32. A machine-readable medium having stored thereon data representing instructions which, when executed by a machine, cause the machine to perform operations comprising:
receiving a signaling message for a frame carried on an optical network, the frame having an overhead portion;
receiving the frame on the optical network from a source node;
reading the overhead portion of the frame to obtain a path identifier for the frame;
comparing the signaling message to the path identifier received in the data frame; and
alternately discarding the frame if the signaling message and the data frame path identifier do not correspond or forwarding the frame if the signaling message and the data frame path identifier do correspond.

33. The medium of claim 32, wherein the instructions for receiving a signaling message comprise instructions which, when executed by the machine, cause the machine to perform further operations comprising reading a path message from a signaling protocol of the optical network.

34. The medium of claim 33, wherein the path message includes a source-ID and a tunnel-ID and wherein the instructions for comparing comprise instructions which, when executed by the machine, cause the machine to perform further operations comprising comparing the source-ID and the tunnel-ID of the path message to codes of the path identifier.

35. The medium of claim 1, wherein the frame is transmitted in a switched circuit, the instructions further comprising;
receiving a second different signaling message for the switched circuit;
receiving further frames of the switched circuit after receiving the second different signaling message;
comparing the path identifier derived from the first signaling message to the path identifier for the further frames; and
alternately discarding further frames if the path identifier derived from the first signaling message and the path identifier for the further frames do not correspond or forwarding further frames if the two path identifiers path identifier derived from the first signaling message and the path identifier for the further frames do correspond.

36. An apparatus comprising:
means for receiving a signaling message for a frame carried on an optical network, the frame having an overhead portion;
means for receiving the frame on the optical network from a source node;
reading the overhead portion of the frame to obtain a path identifier for the frame;
means for comparing the signaling message to the path identifier received in the data frame; and
means for alternately discarding the frame if the signaling message and the data frame path identifier do not correspond or forwarding the frame if the signaling message and the data frame path identifier do correspond.

37. The apparatus of claim 36, wherein the means for receiving a signaling message comprises means for reading identification codes for nodes of the path through the optical network, the node identification codes including an originating node and a node between the originating node and a terminating node, and wherein the means for comparing comprises means for comparing nodes identified in the signaling message to nodes identified in the path identifier.

38. The apparatus of claim 36, wherein the overhead portion containing the path identifier is a part of the received frame and the signaling message is received on a control plane of the optical network.

39. An apparatus comprising:
a data receiver to receive a frame on an optical network and to read an overhead portion of the frame to obtain a path identifier for the frame;
a processor to receive a signaling message for the frame; and
a comparator coupled to the data receiver and the processor to compare the signaling message to the path identifier received in the data frame and to generate an inhibit signal to discard the frame if the signaling message and the data frame path identifier do not correspond.

40. The apparatus of claim 39, further comprising a GMPLS controller to receive the signaling message from a control plane of the optical network.

41. The apparatus of claim 40, wherein the signaling message comprises path message.

42. The apparatus of claim 41, wherein the path message includes a source-ID and a tunnel-ID and wherein the comparator compares the source-ID and the tunnel-ID of the path message to codes of the path identifier.

43. A method comprising:
receiving a signaling message on a control plane, the signaling message specifying a change in a connection for a specified optical network communications circuit;
forwarding the signaling message on the control plane; and
changing the connection for the specified circuit after forwarding the signaling message.

44. The method of claim 43, wherein the signaling message comprises a path message on a GMPLS control plane.

45. The method of claim 43, wherein changing the connection comprises activating a secondary path.

46. The method of claim 43, wherein changing the connection comprises changing the connection without influence from any synchronization messages on the control plane.

47. The method of claim 43, wherein changing the connection comprises changing the connection without influence from any data frames carried by the existing connection.

48. A machine-readable medium having stored thereon data representing instructions which, when executed by a machine, cause the machine to perform operations comprising:
receiving a signaling message on a control plane, the signaling message specifying a change in a connection for a specified optical network communications circuit;
forwarding the signaling message on the control plane; and
changing the connection for the specified circuit after forwarding the signaling message.

49. The medium of claim 48, wherein the signaling message comprises a path message on a GMPLS control plane.

50. The method of claim 48, wherein changing the connection comprises changing the connection without influence from any synchronization messages on the control plane.

51. An apparatus comprising:
means for receiving a signaling message on a control plane, the signaling message specifying a change in a connection for a specified optical network communications circuit;
means for forwarding the signaling message on the control plane; and
means for changing the connection for the specified circuit after forwarding the signaling message.

52. The apparatus of claim 51, wherein the means for changing the connection comprises means for activating a secondary path.

53. The apparatus of claim 51, further comprising means for discarding misrouted data frames.

54. An apparatus comprising:
a controller coupled to a control plane of an optical network to receive a signaling message on the control plane, the signaling message specifying a change in a connection for a specified optical network communications circuit, and to forward the signaling message on the control plane; and
an interface to an optical switching matrix to change the connection for the specified circuit after forwarding the signaling message.

55. The apparatus of claim 54, wherein the controller comprises a GMPLS controller and wherein the signaling message comprises a path message on a GMPLS control plane.

56. A method comprising:
establishing a primary path and a secondary path for a series of frames to be transmitted through an optical network;
attaching a path identifier to frames to be sent over the primary path;
transmitting the frames through the optical network on the primary path with the attached identifier;
upon receiving notification of failure of the primary path, sending a message to activate the secondary path;
after sending the activation message, continuing to attach the identifier to further frames;
transmitting the further frames through the optical network, after sending the activation message and before receiving confirmation of the secondary path activation;
receiving confirmation of the secondary path activation, after transmitting the further frames; and
transmitting frames through the optical network on the secondary path with the attached identifier.

57. The method of claim 56, further comprising establishing the primary and secondary paths through the optical network before transmitting the frames on the primary path.

58. The method of claim 56, further comprising deriving the path identifier from the primary path.

59. The method of claim 56, wherein establishing a primary path comprises sending a path signaling message, the method further comprising deriving the path identifier from the path signaling message.

60. The method of claim 56, wherein the optical network is a circuit switched network and wherein the path identifier identifies a circuit.

61. A machine-readable medium having stored thereon data representing instructions which, when executed by a machine, cause the machine to perform operations comprising:
establishing a primary path and a secondary path for a series of frames to be transmitted through an optical network;
attaching a path identifier to frames to be sent over the primary path;
transmitting the frames through the optical network on the primary path with the attached identifier;
upon receiving notification of failure of the primary path, sending a message to activate the secondary path;
after sending the activation message, continuing to attach the identifier to further frames;
transmitting the further frames through the optical network, after sending the activation message and before receiving confirmation of the secondary path activation;
receiving confirmation of the secondary path activation, after transmitting the further frames; and
transmitting frames through the optical network on the secondary path with the attached identifier.

62. The method of claim 61, further comprising instructions which, when executed by the machine, cause the machine to perform further operations comprising establishing the primary and secondary paths through the optical network before transmitting the frames on the primary path.

63. The method of claim 61, further comprising instructions which, when executed by the machine, cause the machine to perform further operations comprising deriving the path identifier from the primary path.

64. An apparatus comprising:
means for establishing a primary path and a secondary path for a series of frames to be transmitted through an optical network;
means for attaching a path identifier to frames to be sent over the primary path;
means for transmitting the frames through the optical network on the primary path with the attached identifier;
means for sending a message to activate the secondary path upon receiving notification of failure of the primary path;
means for continuing to attach the identifier to further frames; after sending the activation message;
means for transmitting the further frames through the optical network, after sending the activation message and before receiving confirmation of the secondary path activation;
means for receiving confirmation of the secondary path activation, after transmitting the further frames; and
means for transmitting frames through the optical network on the secondary path with the attached identifier.

65. The apparatus of claim 64, wherein the optical network is a circuit switched network and wherein the path identifier identifies a circuit.

66. An apparatus comprising:
a controller to establish a primary path and a secondary path for a series of frames to be transmitted through an optical network, and upon receiving notification of failure of the primary path, to send a message to activate the secondary path;
an interface coupled to the originating node controller to attach a path identifier to frames to be sent over the primary path and the secondary path;
a transmitter coupled to the interface to transmit the frames through the optical network on the primary path and the secondary path with the attached identifier.

67. The apparatus of claim 66, wherein the controller derives the path identifier from the primary path.

68. A method comprising:
establishing a primary path and a secondary path for a series of frames to be transmitted through an optical network from a source node to a destination node;
attaching a path identifier to frames to be sent over the primary path;
carrying the frames from the source node through the optical network on the primary path with the attached identifier;
upon receiving notification of failure of the primary path, propagating a signaling message to nodes of the secondary path to activate the secondary path;
asynchronously switching connections at nodes of the secondary path to activate the secondary path;
carrying the frames from the source node with the attached identifier through the optical network on the secondary path after the secondary path is activated;
discarding messages received at the destination node for which the attached identifier does not correspond to an expected value;
upon completion of activation of the secondary path, propagating a signaling message to nodes of the primary path to deactivate the primary path; and
asynchronously switching connections at nodes of the primary path to deactivate the primary path.

69. The method of claim 68, further comprising deriving the path identifier at the destination node from the primary path.

70. The method of claim 68, wherein establishing a primary path comprises carrying a path signaling message to nodes of the primary path, the method further comprising deriving the path identifier at the source node and the destination node from the path signaling message.

71. The method of claim 68, wherein the optical network is a circuit switched network and wherein the path identifier identifies a circuit.

72. A communications system comprising:
means for establishing a primary path and a secondary path for a series of frames to be transmitted through an optical network from a source node to a destination node;
means for attaching a path identifier to frames to be sent over the primary path;
means for carrying the frames from the source node through the optical network on the primary path with the attached identifier;
means for propagating a signaling message to nodes of the secondary path to activate the secondary path, upon receiving notification of failure of the primary path;
means for asynchronously switching connections at nodes of the secondary path to activate the secondary path;
means for carrying the frames from the source node with the attached identifier through the optical network on the secondary path after the secondary path is activated;
means for discarding messages received at the destination node for which the attached identifier does not correspond to an expected value;
means for propagating a signaling message to nodes of the primary path to deactivate the primary path, upon completion of activation of the secondary path; and
means for asynchronously switching connections at nodes of the primary path to deactivate the primary path.

73. The apparatus of claim 72, wherein the means for establishing a primary path comprises means for carrying a path signaling message to nodes of the primary path, the apparatus further comprising means for deriving the path identifier at the source node and the destination node from the path signaling message.

74. A data communications system comprising:
a source node controller coupled to a control plane to establish a primary path and a secondary path for a series of frames to be transmitted through an optical network from the source node to a destination node, upon receiving notification of failure of the primary path, to propagate a signaling message to nodes of the secondary path to activate the secondary path, and upon completion of activation of the secondary path, to propagate a signaling message to nodes of the primary path to deactivate the primary path;
a source interface to attach a path identifier to frames to be sent over the primary path;
a primary path optical data plane to carry the frames from the source node through the optical network on the primary path with the attached identifier;
controllers at each node of the secondary path coupled to the control plane to receive the signaling message from the source node controller and to asynchronously switch connections at nodes of the secondary path to activate the secondary path;
controllers at each node of the primary path coupled to the control plane to receive the signaling message from the source node controller and to asynchronously switch connections at nodes of the primary path to deactivate the primary path;
a secondary path optical data plane to carry the frames from the source node with the attached identifier through the optical network on the secondary path after the secondary path is activated; and
a destination node interface coupled to the primary and secondary optical data plane to receive frames and to discard frames received at the destination node for which the attached identifier does not correspond to an expected value.

75. The apparatus of claim 74, wherein the destination node interface derives the path identifier at the destination node from the primary path.

76. The method of claim 74, wherein the data communications system comprises a circuit switched optical network and wherein the path identifier identifies a circuit.
